(19) United States
(12) Patent Application Publication
(10) Pub. No.: US 2014/0290365 A1
(43) Pub. Date: Oct. 2, 2014

(54) MEMS DEVICE

(71) Applicant: Tao Ju, Beijing (CN)

(72) Inventor: Tao Ju, Beijing (CN)

(21) Appl. No.: 13/854,972

(22) Filed: Apr. 2, 2013

(51) Int. Cl. G01P 3/44

(52) U.S. Cl. CPC G01P 3/443
USPC 73/514.39

(57) ABSTRACT

A MEMS gyro is provided, having a movable portion, a non-movable portion, and a magnetic sensing structure that comprises a magnetic source disposed at the movable portion, a magnetic sensing element positioned at the non-movable portion. The movable portion is capable of moving in response to external angular velocity or an external accelerator such that the magnetic field sensed by the magnetic sensing element is in relation to the movement of the movable portion, therefore, the angular velocity or the accelerator.

### CROSS-REFERENCE

This US utility patent application claims priority from co-pending US utility patent application “A HYBRID MEMS DEVICE,” Ser. No. 13/559,625 filed Jul. 27, 2012, which claims priority from US provisional patent application “A HYBRID MEMS DEVICE,” filed May 31, 2012, serial number 61/653,408 to Biao Zhang and Tao Ju, the subject matter of each of which is incorporated herein by reference in its entirety.

### TECHNICAL FIELD OF THE DISCLOSURE

The technical field of the examples to be disclosed in the following sections is related generally to the art of microstructure, and, more particularly, to MEMS devices comprising MEMS mechanical moving structures and MEMS magnetic sensing structures.

### BACKGROUND OF THE DISCLOSURE

Microstructures, such as microelectromechanical (hereafter MEMS) devices (e.g. accelerometers, DC relay and RF switches, optical cross connects and optical switches, microlenses, reflectors and beam splitters, filters, oscillators and antenna system components, variable capacitors and inductors, switched banks of filters, resonant comb-drives and resonant beams, and micromirror arrays for direct view and projection displays) have many applications in basic signal transduction. For example, a MEMS gyroscope measures angular rate.

A gyroscope (hereafter “gyro” or “gyroscope”) is based on the Coriolis effect as diagrammatically illustrated in FIG. 1. Proof-mass 100 is moving with velocity V_{d}. Under external angular velocity Ω, the Coriolis effect causes movement of the poof-mass (100) with velocity Vₛ. With fixed V_{d}, the external angular velocity can be measured from V_{d}. A typical example based on the theory shown in FIG. 1 is capacitive MEMS gyroscope, as diagrammatically illustrated in FIG. 2.

The MEMS gyro is a typical capacitive MEMS gyro, which has been widely studied. Regardless of various structural variations, the capacitive MEMS gyro in FIG. 2 includes the very basic theory based on which all other variations are built. In this typical structure, capacitive MEMS gyro 102 is comprised of proof-mass 100, driving mode 104, and sensing mode 102. The driving mode (104) causes the proof-mass (100) to move in a predefined direction, and such movement is often in a form of resonance vibration. Under external angular rotation, the proof-mass (100) also moves along the Vₛ direction with velocity Vₛ. Such movement of Vₛ is detected by the capacitor structure of the sensing mode (102). Both of the driving and sensing modes use capacitive structures, whereas the capacitive structure of the driving mode changes the overlaps of the capacitors, and the capacitive structure of the sensing mode changes the gaps of the capacitors.

Current capacitive MEMS gyros, however, are hard to achieve submicro-g/rtHz because the capacitance between sensing electrodes decreases with the miniaturization of the movable structure of the sensing element and the impact of the stray and parasitic capacitance increase at the same time, even with large and high aspect ratio proof-masses.

Therefore, what is desired is a MEMS device capable of sensing angular velocities.

### SUMMARY OF THE DISCLOSURE

In view of the foregoing, a MEMS device is disclosed herein. The MEMS comprising: a MEMS device, comprising: a first substrate, comprising: a magnetic field detector; a second substrate, comprising: a movable portion that is suspended above the first substrate, and is capable of moving relative to the magnetic field detector, said movable portion being able to move along a first direction and a second direction that is substantially perpendicular to the first direction; a magnetic driving mechanism coupled to the movable portion such that the movable portion is capable of moving under a magnetic field by the magnetic driving mechanism; and a magnetic field generation mechanism positioned between the movable portion and the first substrate, and in the vicinity of the magnetic field detector.

In another example, disclosed herein comprises a MEMS device, comprising: a first substrate comprising a movable portion, said movable portion comprising: a magnetic source; a magnetic driving mechanism coupled to said movable portion such that said movable portion is capable of moving in a plane parallel to the first substrate under the magnetic forced applied to the movable portion by said magnetic driving mechanism; and a second substrate distanced apart from the first substrate, wherein the first and second substrates are substantially parallel, said second substrate comprising: a magnetic sensor capable of detecting a magnetic signal from the magnetic source.

### BRIEF DESCRIPTION OF DRAWINGS

FIG. 1 diagrammatically illustrates the Coriolis effect in a MEMS structure;

FIG. 2 is a top view of a typical existing capacitive MEMS gyroscope having a driving mode and a sensing mode, wherein both of the driving and sensing mode utilize capacitance structures;

FIG. 3a diagrammatically illustrates an exemplary MEMS gyro of this disclosure, wherein the MEMS gyro comprising a magnetic sensing structure for sensing the movement of the proof-mass;

FIG. 3b diagrammatically illustrates an exemplary magnetic driving mechanism of the example illustrated in FIG. 3a;

FIG. 3c diagrammatically illustrates another exemplary MEMS gyro of this disclosure, wherein the MEMS gyro comprising a magnetic sensing structure for sensing the movement of the proof-mass;

FIG. 3d diagrammatically illustrates yet another exemplary MEMS gyro of this disclosure, wherein the MEMS gyro comprising a magnetic sensing structure for sensing the movement of the proof-mass;

FIG. 3e diagrammatically illustrates a side view of the MEMS gyro in FIG. 3a along line AA;

FIG. 4a diagrammatically illustrates another exemplary MEMS gyro of this disclosure, wherein the sensing structure of the MEMS gyro comprises a magnetic sensing element and a reference element;

FIG. 4b diagrammatically illustrates an exemplary layout of the magnetic sensing element and reference element on the substrate in FIG. 4a;

FIG. 5 diagrammatically illustrates another exemplary MEMS gyro in this disclosure, wherein the MEMS gyro comprises multiple sensing structures;

FIG. 6 diagrammatically illustrates an exemplary configuration of the magnetic sensing elements and magnetic sources on separate substrates, wherein the magnetic sensing elements and magnetic sources are arranged as series;

FIG. 7 diagrammatically illustrates another exemplary configuration of the magnetic sensing elements, reference sensors, and magnetic sources on separate substrates, wherein the magnetic sensing elements and magnetic sources are arranged as series;

FIG. 8 diagrammatically illustrates another exemplary MEMS gyro in this disclosure, wherein the MEMS gyro comprises a sensing structure and the magnetic source has a part embedded inside the body of the proof-mass;

FIG. 9 diagrammatically illustrates another exemplary MEMS gyro in this disclosure, wherein the MEMS gyro comprises a sensing structure and the sensing structure comprises a conducting wire to generate external magnetic field for magnetizing the magnetic source of the sensing element;

FIG. 10 diagrammatically illustrates the layout of the conducting wire and the sensing element in FIG. 9;

FIG. 11 diagrammatically illustrates another exemplary MEMS gyro in this disclosure, wherein the MEMS gyro comprises a sensing structure and the sensing structure comprises a conducting wire to generate external magnetic field for magnetizing the magnetic source of the sensing element;

FIG. 12 diagrammatically shows the relative position of the magnetic source to the magnetic sensing element during a moving course;

FIG. 13 is a diagram showing the magnetic signal strength sensed by the sensing elements when the magnetic source is at different positions shown in FIG. 12.

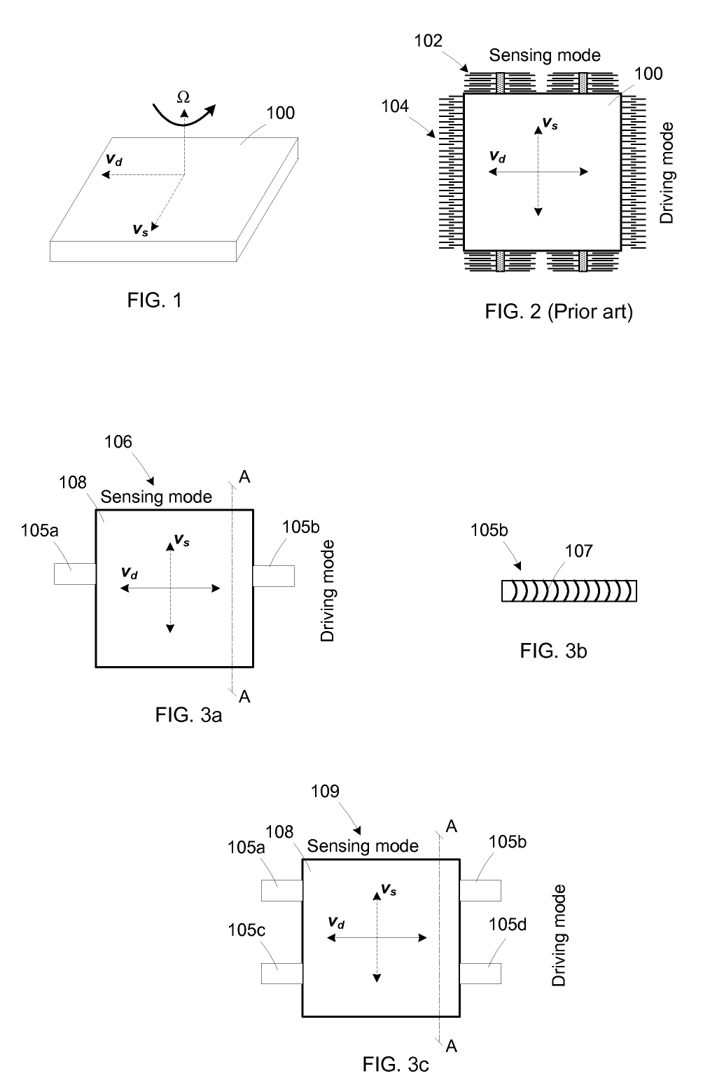

### DETAILED DESCRIPTION OF SELECTED EXAMPLES

Disclosed herein is a MEMS gyro that utilizes a magnetic sensing mechanism for sensing the movement of the proof-mass. It will be appreciated by those skilled in the art that the following discussion is for demonstration purposes, and should not be interpreted as a limitation. Many other variations within the scope of the following disclosure are also applicable.

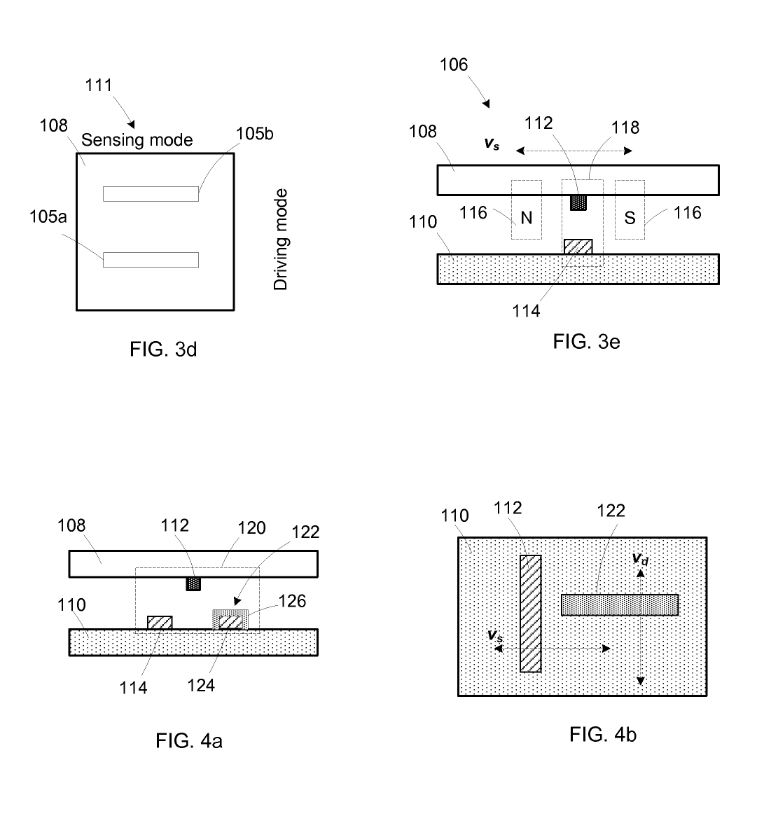

Referring to FIG. 3a, an exemplary MEMS gyro of this disclosure is schematically illustrated herein. MEMS gyro 106 comprises a proof-mass (108), a driving mode, and a sensing mode. The driving mode comprises a capacitive structure for driving the proof-mass (108) to moving along V_{d}, which the proof-mass can move at its resonance frequency. The sensing mode comprises a magnetic sensing structure (detailed in FIG. 3b) for sensing the movement of the proof-mass. In contrast to the current capacitive MEMS gyros, the MEMS gyro shown in FIG. 3a may does not utilize capacitive structure, though it is not necessary. The magnetic sensing structure of the sensing mode is illustrated in FIG. 3b.

FIG. 3b diagrammatically illustrates a side view of the MEMS gyro along line AA shown in FIG. 3a. AS shown in FIG. 3b, the MEMS gyro (106) comprises a magnetic sensing structure (118). The magnetic sensing structure (118) is comprised of magnetic source 112 on proof-mass 108 and magnetic sensing element 114 on substrate 110. The magnetic sensing element 114 can be any suitable devices capable of detecting small magnetic field signals, such as signals of 500 Oe or less, preferably 200 Oe or less, 100 Oe or less, 20 Oe or less. In one example, the magnetic sensing element can be a Giant-Magneto-Resistance (GMR) sensor, such as a Spin-Valve (SV) or a Magnetic-Tunnel-Junction (MTJ) sensor.

The magnetic source (112) introduces magnetic field around its location. By moving along with the proof-mass 118 relative to the magnetic sensing element (114), the magnetic field generated by the magnetic source (112) varies. Such magnetic field variation is measured by the magnetic sensing element (114), from the measurement of which, the movement of the proof-mass (108) is detected. Because the movement of the proof-mass (108) is caused by the external angular velocity, such angular velocity can thus be derived from the detected movement of the proof-mass (108).

In general, the movement of the proof-mass (108) along Vₛ is small, which is in the order of angstroms or nanometers in amplitude. The magnetic field change caused by the movement of proof-mass 108 is often small, which can be several oersted (Oe) or even less. As such, the magnetic source 112 is often desired to have a characteristic matching the amplitude of the moving proof-mass 108. In one example, the magnetic source 112 can have a characteristic dimension of nanometers or less, such as 2 micros or less, 1 micro or less, 500 nanometers or less, 100 nanometers or less, 50 nanometers or less, 20 nanometers or less, 5 nanometers or less. The magnetic sensing element (114) is desired to be capable of detecting the magnetic field strength generated by the magnetic source (112), and/or the magnetic field variation.

The magnetic source (112) can be comprised of a conducting wire. By introducing current into the conducting wire, a magnetic field can thus be generated around the location of the conducting wire. The magnetic source (112) can also be comprised of a magnetic material, such as Fe₃O₄, Co, or many other suitable materials. However, when the magnetic source (112) comprised of a magnetic material is configured to have a size less than a critical value, such as 20 nanometers or less, the magnetic source may exhibit super-paramagnetic behavior. As such, a magnetization mechanism 116 may be necessary for magnetizing the superparamagnetic source 112. The magnetization mechanism (116) can be configured into many forms, such as conducting wires, permanent magnets. Regardless of the specific forms, the magnetization mechanism (116) can be integrated with the magnetic sensing structure (118), or can be in a form of separate functional unit from the magnetic sensing structure, which will be detailed afterwards.

For increased performance, a magnetic sensing structure may comprise a reference sensor, as diagrammatically illustrated in FIG. 4a. Referring to FIG. 4a, sensing structure 120 in this example comprises magnetic source 112 for generating magnetic field, magnetic sensing element 114 for detecting the generated magnetic field (and/or the magnetic field change), and reference sensor 122 for providing reference signals for the detection of the proof-mass movement. The reference sensor (122) comprises a magnetic sensing structure (124) and magnetic shield 126 covering the magnetic sensing structure (124). The magnetic sensing structure 124 may have substantially the same physical structure as the magnetic sensing element 114, except for the geometric layout. In one example wherein the magnetic sensing element 114 comprises a GMR structure (e.g. a SV or a MTJ), the magnetic sensing structure 124 may have the same film stack (e.g. in the form of SV or MTJ) as the magnetic sensing element 114. However, because the reference sensor 122 is designated for providing reference signals, it is desirable to magnetically isolate the magnetic sensing structure 124 from the magnetic field generated by the magnetic source 112. For this purpose, the magnetic sensing structure 124 is covered by magnetic shield 126, which can be comprised of a soft magnetic material.

The reference sensor 122 can be disposed relative to the magnetic sensing element 114 in any suitable ways, one of which is schematically illustrated in FIG. 4b. Referring to FIG. 4b, the magnetic sensing element 112 is geometrically aligned such that its width (the magnetization direction) is substantially parallel to the moving direction of Vₛ, and its length (the easy axis) is substantially perpendicular to Vₛ when viewed from the top. The reference sensor 122 is aligned to be perpendicular to the magnetic sensing element 112. Specifically, the lengths of the magnetic sensing element 112 and reference sensor are substantially perpendicular. Alternatively, the length of the magnetic sensing element 112 can be substantially perpendicular to the moving direction of Vₛ, while the length of the reference sensor 122 is substantially perpendicular to the driving direction V_{d}. It will be appreciated by those skilled in the art that the configuration as discussed above with reference to FIG. 4a and FIG. 4b is for demonstration purposes, and many other variations are also applicable.

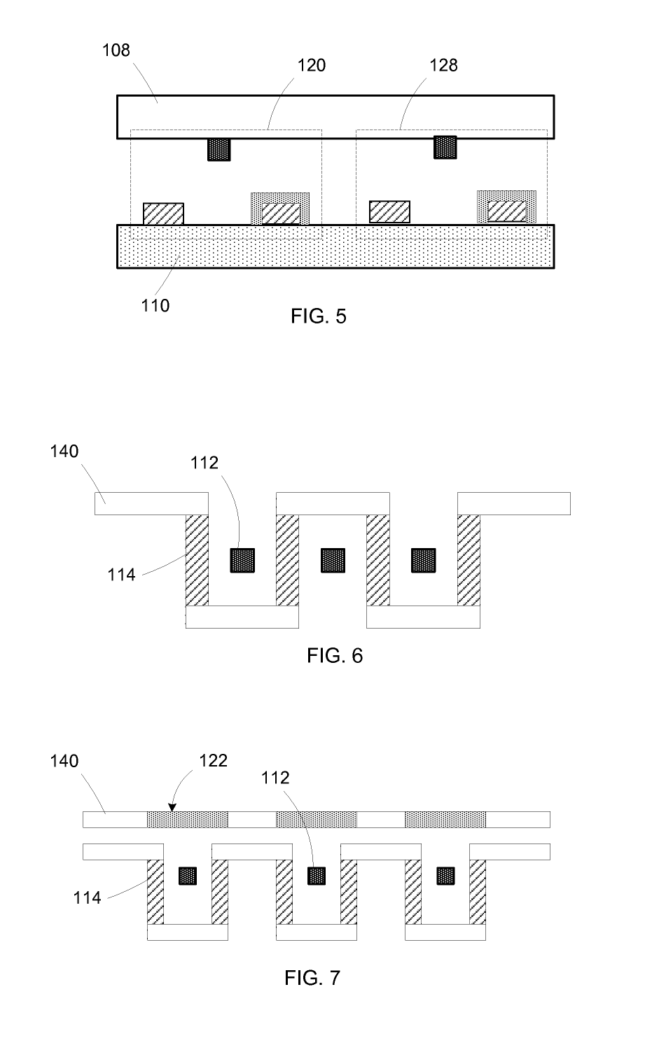

A MEMS gyro may comprise multiple sensing structures, an example of which is diagrammatically illustrated in FIG. 5. Referring to FIG. 5, multiple sensing structures, such as 120 and 128 are provided for a MEMS gyro. In this exemplary configuration, the sensing structures can be operated independently. Alternatively, the magnetic sources can be configured to form an array, as diagrammatically shown in FIG. 6.

Referring to FIG. 6, the magnetic sensing elements (e.g. 114) are disposed substantially parallel and electrically connected serially by conducting wires (e.g. 140). The magnetic sources (e.g. 112) are positioned between adjacent magnetic sensing elements such that the moving direction of Vₛ is perpendicular to the length (easy axis) of the magnetic sensing elements. It is noted that the magnetic sensing elements are on one substrate, while the magnetic sources are disposed on the proof-mass (or a portion that moves with the proof-mass) that can move relative to the substrate on which the sensing elements are disposed.

The reference sensors can also be configured serially as the magnetic sensing elements, as illustrated in FIG. 7. Referring to FIG. 7, reference sensors (e.g. 122) are electrically connected serially by conducting wires, such as 140. The reference sensors are substantially perpendicular to the magnetic sensing elements, which specially, the easy axes of the reference sensors are substantially perpendicular to the easy axes of the magnetic sensing elements. Each reference element is dispose between adjacent magnetic sensing elements, as illustrated in FIG. 7.

It is noted that the reference sensors and magnetic sensing elements, in relation to the magnetic sources can be configured into many other ways, which will not be detailed herein. For example, the magnetic sensing elements and the reference sensors can actually be disposed on separate layers that are parallel, though this configuration is more complicate in terms of fabrication. In such configuration, when viewed from the top, the reference sensors can be aligned substantially to the magnetic sources—e.g., when viewed from the top, the magnetic sources are substantially aligned to the underneath reference sensors. In relation to the perpendicularly positioned magnetic sensing elements, the reference sensors (one a separate layer) can be on substantially the middle portions of the magnetic sensing elements, which are not shown in the drawings. Even though such configuration increases the fabrication process, it may increase the measurement accuracy and/or the electrical circuit design.

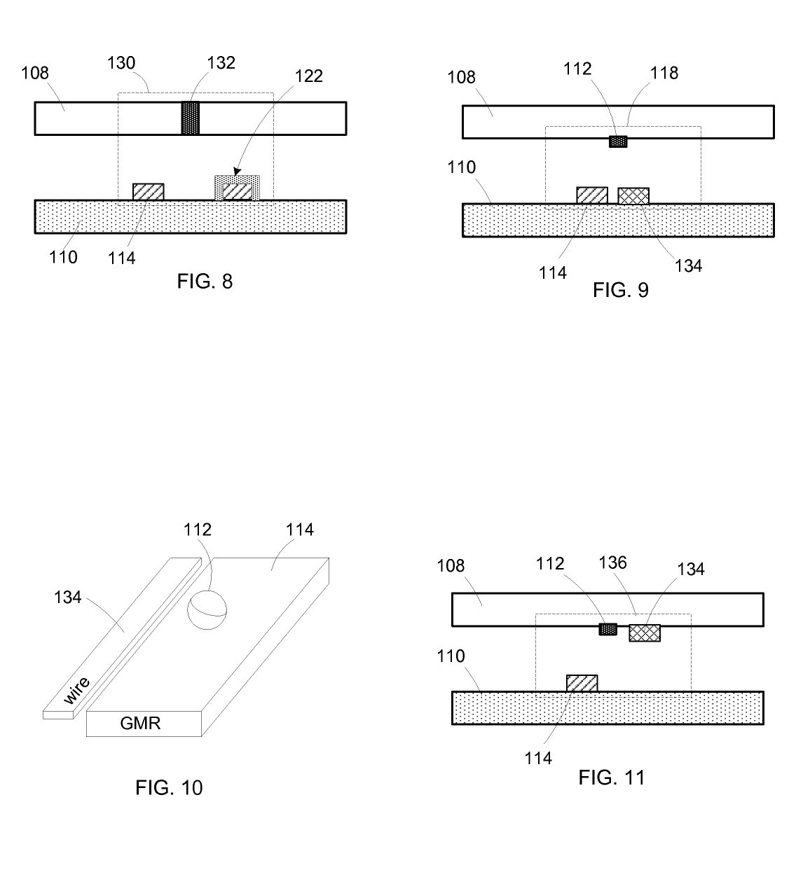

The magnetic sources, in general, can be disposed on a major surface (e.g. the major bottom surface) of the movable proof-mass (or a portion connected or disconnected to the proof-mass but being able to move along with the proof-mass relative to the sensing elements). Alternatively, a magnetic source can be embedded in the proof-mass or a portion connected or disconnected to the proof-mass but being able to move along with the proof-mass relative to the sensing elements. Specifically, a portion of a magnetic source can be inside the body (e.g. between the upper and bottom major surfaces) of the proof-mass. FIG. 8 diagrammatically illustrates such an example. As shown in FIG. 8, magnetic source 132 of magnetic sensing structure 130 is embedded in the proof-mass (108). The embedded magnetic source (e.g. 132) can be formed by many ways, such as a photolithography (to form a trench at a desired location on the proof-mass) process followed by a film deposition process (e.g. magnetic sputtering process).

In examples wherein the magnetic sources are comprised of magnetic materials and exhibit super-paramagnetic properties, magnetization fields may be necessary to magnetize the magnetic sources. The magnetization fields can be generated in many suitable ways, such as permanent magnetism, or conducting wires as diagrammatically illustrated in FIG. 9.

Referring to FIG. 9, magnetic sensing structure 118 comprises conducting wire 134 for magnetizing magnetic source 112, such that the fringe field of the magnetic source 112 can be sensed by magnetic sensing element 114. The detailed structure of sensing element 114 and conducting wire 134 is diagrammatically illustrated in FIG. 10.

Referring to FIG. 10, conducting wire 134 is substantially parallel to the length of magnetic sensing element 114, wherein the length direction is the easy axis of the magnetic sensing element that is a GMR having a free magnetic layer. When introduced electrical current, the current generates magnetic field that magnetizes magnetic source 112. The magnetized magnetic source 112 generates induced magnetic field that overlaps with the magnetization field from the current in the conducting wire 134. Both magnetic fields are substantially aligned to the width (the magnetization direction, which is perpendicular to the easy axis of the magnetic sensing element 114) of the magnetic sensing element 114. The magnetic field sensed by the magnetic sensing element 114 can be the additive of the two magnetic fields.

Other than disposing the conducting wire on the same substrate as the magnetic sensing element 114, the conducting wire for magnetizing the magnetic source (112) can be positioned on the proof-mass 108, as diagrammatically illustrated in FIG. 11. Referring to FIG. 11, the conducting wire 134 is positioned in the vicinity of magnetic source 112 and on the same substrate (e.g. the proof-mass 108) as the magnetic source.

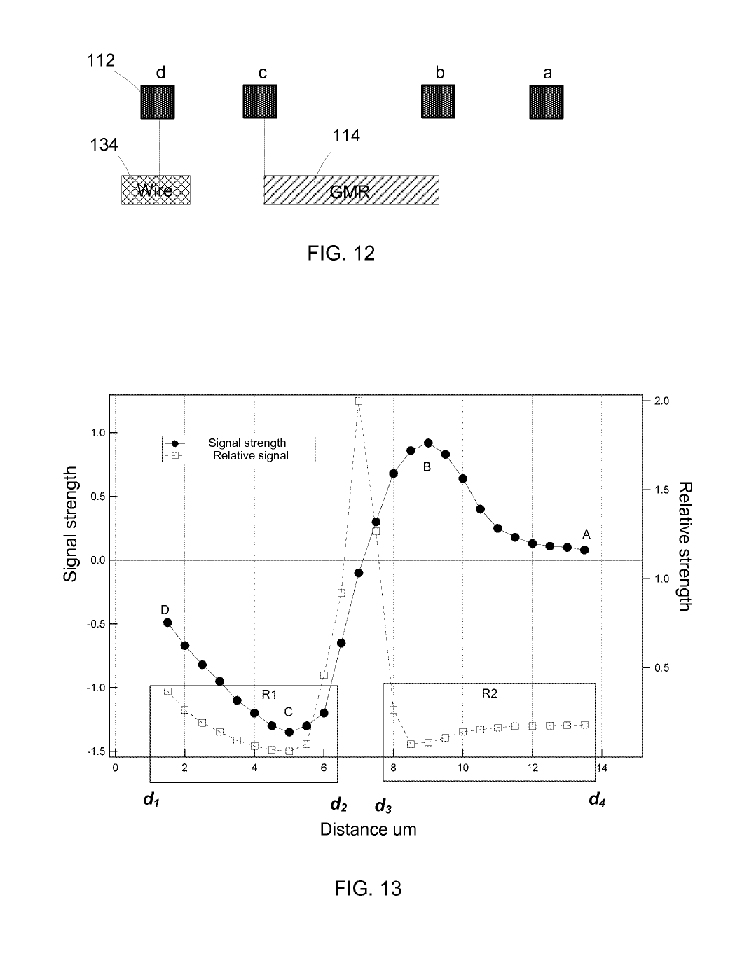

In examples wherein the magnetic source (112) is to be magnetized by a conducting wire (e.g. 134), it can be advantageous to align the magnetic source (112) and magnetic sensing element (114) with an offset, which is detailed with reference to FIG. 12 and FIG. 13.

Referring to FIG. 12, it is assumed that the magnetic sensing element 114 and the conducting wire 134 are fixed at predetermined positions, and the magnetic source 112 can be disposed at four individual positions: a, b, c, and d. At position a, the magnetic source 112 is far away from both conducting wire 134 and magnetic sensing element 114. At position b, the magnetic source 112 is aligned to one short side (along the width) of the magnetic sensing element (114), wherein the magnetic sensing element 114 is between the conducting wire 134 and magnetic source 112 (at position b). At position c, the magnetic source 112 is between the conducting wire 134 and magnetic sensing element 114 and aligned substantially to the other side (along the width) of the magnetic sensing element 134. At position d, the magnetic source is substantially aligned to the conducting wire 134, as shown in FIG. 12. The signal strength and relative signal strength sensed by the magnetic sensing element 114 are shown in FIG. 13.

Referring to FIG. 13, the signal strength at both positions a and d are low. The maximum signal strength appear at positions b and c. The signal strength sensed by the magnetic sensing element 114 is substantially linear between positions c and b. Therefore, it is advantageous to dispose the magnetic source at position c or b, wherein c is more preferred.

As mentioned above, the magnetic source can be in many other suitable forms, in addition to magnetism. For example, the magnetic source can be conducting wires, and the conducting wire can be in a form of loop, segment, line, dotted line or any combinations thereof.

Other variations of the above discussed embodiments are also applicable. For example, the magnetic source can be disposed at the non-movable portion (e.g. 114), while the magnetic sensing element can be disposed at the movable portion (e.g. proof-mass 108).

It will be appreciated by those of skilled in the art that a new and useful MEMS gyroscope has been described herein. In view of the many possible embodiments, however, it should be recognized that the embodiments described herein with respect to the drawing figures are meant to be illustrative only and should not be taken as limiting the scope of what is claimed. Those of skill in the art will recognize that the illustrated embodiments can be modified in arrangement and detail. Therefore, the devices and methods as described herein contemplate all such embodiments as may come within the scope of the following claims and equivalents thereof. In the claims, only elements denoted by the words “means for” are intended to be interpreted as means plus function claims under 35 U.S.C. §112, the sixth paragraph.

We claim:

1. A MEMS device, comprising:
a first substrate comprising a movable portion, said movable portion comprising a magnetic source;
a magnetic driving mechanism coupled to said movable portion such that said movable portion is capable of moving in a plane parallel to the first substrate under the magnetic forced applied to the movable portion by said magnetic driving mechanism; and
a second substrate distanced apart from the first substrate, wherein the first and second substrates are substantially parallel, said second substrate comprising:
a magnetic sensor capable of detecting a magnetic signal from the magnetic source.

2. The MEMS of claim 1, wherein the magnetic driving mechanism comprises a coil and a magnet coupled to the coil, and wherein the coil is electrically connected to a current source such that the coil is capable of generating an alternating magnetic field around the magnet.

3. The MEMS device of claim 2, wherein coil is connected to the movable portion of the first substrate, and the magnet is affixed to a non-movable portion that is substantially non-movable relative to the coil.

4. The MEMS device of claim 3, further comprising:
a second magnetic driving mechanism comprising a coil and a magnet that is coupled to the coil; and
wherein said magnetic driving mechanism and the second magnetic driving mechanism are positioned on the opposite sides of the movable portion.

5. The MEMS device of claim 3, wherein said magnetic driving mechanism is positioned inside the movable position.

6. The MEMS device of claim 4, wherein said magnetic driving mechanism and said second magnetic driving mechanism are positioned inside the movable portion.

7. The MEMS device of claim 1, wherein the magnetic sensor comprises a giant-magneto-resistor.

8. The MEMS device of claim 7, wherein the giant-magneto-resistor comprises a spin-valve structure.

9. The MEMS device of claim 7, wherein the giant-magneto-resistor comprises a magnetic-tunnel-junction structure.

10. The MEMS device of claim 7, wherein the giant-magneto-resistor comprises a AMR structure.

11. The MEMS device of claim 3, wherein the magnetic source is super-paramagnetic, and the magnetic sensing structure further comprises a magnetization mechanism for magnetizing the magnetic source.

12. The MEMS device of claim 3, wherein the magnetization mechanism comprises a permanent magnetism.

13. The MEMS device of claim 12, wherein the magnetization mechanism comprises a conducting wire.

14. The MEMS device of claim 13, wherein the magnetic source is offset from the magnetic sensing element, such that the geometric center of the magnetic source is closer to one major size than the other major side of the magnetic sensing element.

15. The MEMS device of claim 13, wherein the conducting wire is positioned at the non-movable portion.

16. A MEMS device, comprising:
a first substrate, comprising:
a magnetic field detector;
a second substrate, comprising:
a movable portion that is suspended above the first substrate, and is capable of moving relative to the magnetic field detector, said movable portion being able to move along a first direction and a second direction that is substantially perpendicular to the first direction;
a magnetic driving mechanism coupled to the movable portion such that the movable portion is capable of moving under a magnetic field by the magnetic driving mechanism; and
a magnetic field generation mechanism positioned between the movable portion and the first substrate, and in the vicinity of the magnetic field detector.

17. The MEMS device of claim 16, wherein the magnetic field generation mechanism comprises a conducting wire.

18. The MEMS device of claim 16, wherein the magnetic field generation mechanism comprises a nanostructure comprised of a magnetic material.

19. The MEMS device of claim 16, wherein the magnetic field generation mechanism comprises a first conducting wire and a second conducting wire that is positioned substantially perpendicular to the first conducting wire.
